(19) United States
(12) Patent Application Publication
(10) Pub. No.: US 2021/0392162 A1
(43) Pub. Date: Dec. 16, 2021

(54) NOVEL DNS RECORD TYPE FOR NETWORK THREAT PREVENTION

(71) Applicant: Patrick Kidney, New York, NY (US)

(72) Inventor: Patrick Kidney, New York, NY (US)

(21) Appl. No.: 17/391,999

(22) Filed: Aug. 2, 2021

Related U.S. Application Data
(60) Provisional application No. 63/059,470, filed on Jul. 31, 2020.

(51) Int. Cl. H04L 29/06; H04L 29/12

(52) U.S. Cl. CPC H04L 63/1458; H04L 63/1416; H04L 61/2015; H04L 63/1466; H04L 63/20; H04L 63/1425

(57) ABSTRACT

A method for identifying a source of network attack by proving an autonomous system number record (ASN record) that includes an IP address, a public autonomous system number (public ASN), and a private autonomous system number (private ASN). The public ASN and the private ASNs can be unique randomly generated combination of numbers. The IP address and the public ASN can be incorporated in the network packets for tracking a route of the network packets in a network.

### CROSS-REFERENCE TO RELATED APPLICATIONS

This application claims priority from the U.S. provisional patent application Ser. No. 63/059,470, filed on Jul. 31, 2020, which is incorporated herein by reference in its entirety.

### FIELD OF INVENTION

The present invention relates to a DNS record type, and more particularly, the present invention relates to a DNS record type that aids in identification and mitigation of persistent network threats.

### BACKGROUND

Unauthorized access to a network in order to cause harm or steal information is referred to as a network attack. A network can be compromised in a number of ways and the hackers keep developing more sophisticated ways of harming a network or steal data. Denial of service attack (DoS) is a type of network attack that overwhelms network resources resulting in denying the services to legitimate users. Such services can include websites, Emails, banking, eCommerce, and like. DoS can be accomplished by flooding a targeted host or network with traffic until the target cannot respond or simply crashes, making the services inaccessible to legitimate users. A distributed denial-of-service (DDoS) attack refers to DoS when multiple machines target a single host. DDoS attackers often leverage the use of a botnet-a group of hijacked internet-connected devices to conduct large-scale attacks. These kinds of attacks exploit the features of TCP and HTTP protocols.

DoS attacks are difficult to control. A typical solution is to identify and block computers from which the attacks are executed. However, identifying such computers is difficult and often results in false positives i.e., blocking a computer of a legitimate user. The hackers generally hide their IP addresses by methods generally knows as IP spoofing. Ip spoofing refers to modifying the source address in an Internet Protocol (IP) packet to hide the identity of the sender. IP spoofing is used by DDoS attackers to hide their identities. Similar, the IP address are hide in other network attacks and it becomes very difficult and often impossible to locate the attacker.

Thus, a need is appreciated for a solution that can aid locating the attacking device(s) and block the same.

Hereinafter, autonomous system number(s) are also referred to as ASNs and both are interchangeably used.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for identifying host devices in a network.

It is another object of the present invention that the system and method can provide for tracking network packets in a packet switched network.

It is still another object of the present invention that the system and method can track a route taken by the network packets from host to client.

It is yet another object of the present invention that the source of network attacks can be located and blocked.

It is a further object of the present invention that the persistent network attacks can be blocked.

It is still a further object of the present invention that DoS type network attacks can be blocked.

It is yet a further object of the present invention that IP spoofing-based network attacks can be blocked.

It is an additional object of the present invention that the source of a cyber threat or attack can be identified.

In one aspect, disclosed is a method for identifying a source of network attack, the method can include the steps of proving an autonomous system number record (ASN record) that includes an IP address, a public autonomous system number (public ASN), and a private autonomous system number (private ASN) in a host device; and incorporating the IP address and the public ASN in network packets transmitted by the host device.

In one implementation of the method, the method may further include the steps of transmitting, by the host device, a DHCP request to the Dynamic Host Configuration Protocol server; and receiving, by a Dynamic Host Configuration Protocol server from an ASN generator, the public ASN and the private ASN. The ASN generator can be implemented within a system, the system comprises a processor and a memory, the memory includes the ASN generator and a registry, the method further comprises the steps of recording the public ASN and the private ASN in the registry.

In one implementation of the method, the method may further include the steps of tracking a route of the network packets in a network, transmitted by the host device to a client device, using the public ASN number and the private ASN number; and blocking the host device by the client device from receiving the network packets.

In one aspect, disclosed is a method for identifying a source of network attack by proving an autonomous system number record (ASN record) that includes an IP address, a public autonomous system number (public ASN), and a private autonomous system number (private ASN). The public ASN and the private ASNs can be unique randomly generated combination of numbers. The IP address and the public ASN can be incorporated in the network packets for tracking a route of the network packets in a network.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a schematic diagram showing the ASN numbers assignment in an internal network, according to an exemplary embodiment of the present invention.

FIG. 2 is an environmental diagram showing the assignment of ASN numbers, according to an exemplary embodiment of the present invention.

FIG. 3 is block diagram showing a system architecture, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a DNS record type that can identify hosts in a network and can also track a route of network packets in a network to identify the real source of packets. Disclosed is a method to track the source of network packets and block the same, including the spoofed network packages having a spoofed IP address. Disclosed DNS record type can help to locate the source of DoS attacks, DDoS attacks, and other IP spoofing-based attacks by tracking the route of the spoofed network packets in the network.

Disclosed are autonomous system numbers (ASN) that can be configured in host devices, switches, and like devices in a network. Also disclosed is a novel DNS record type, referred herein as an ASN Record that contains an IP address, a private ASN, and a public ASN. The ASN record can help identify and confirm the source private and public ASNs of a network connection from outside the firewall. These records can also be used internally and be populated by a Dynamic Configuration Protocol extension that can essentially assign an IP Address as it typically does but have added steps of capturing both public and private ASNs from the internal infrastructure and routers.

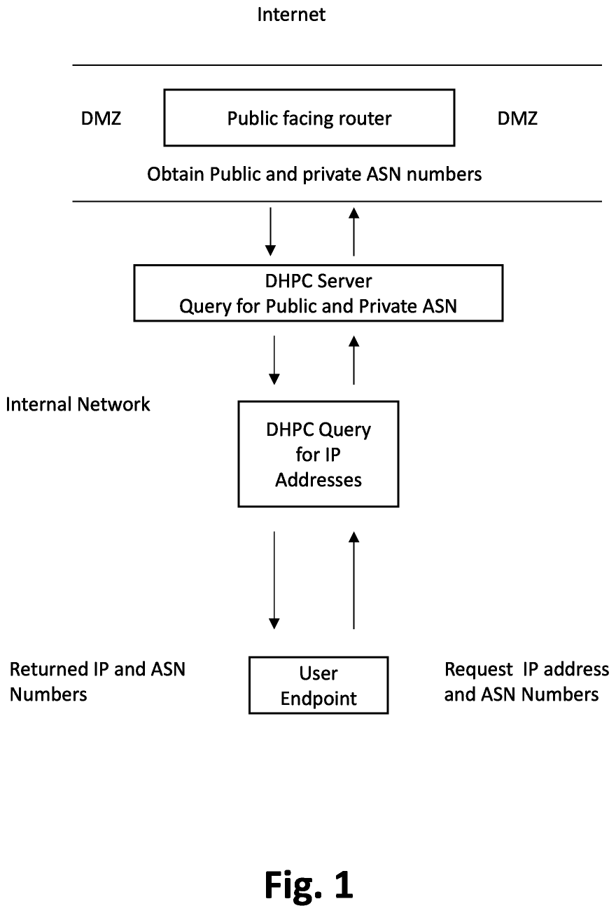

Referring to FIG. 1, which shows a schematic diagram showing the assignment of ASN numbers in an internal network. The host device, also referred herein as the endpoint, can generate a DHCP query for IP address and ASN numbers. The DHCP protocol in the router can obtain the public and private ASNs form the disclosed system and assign the same to the host along with the IP address.

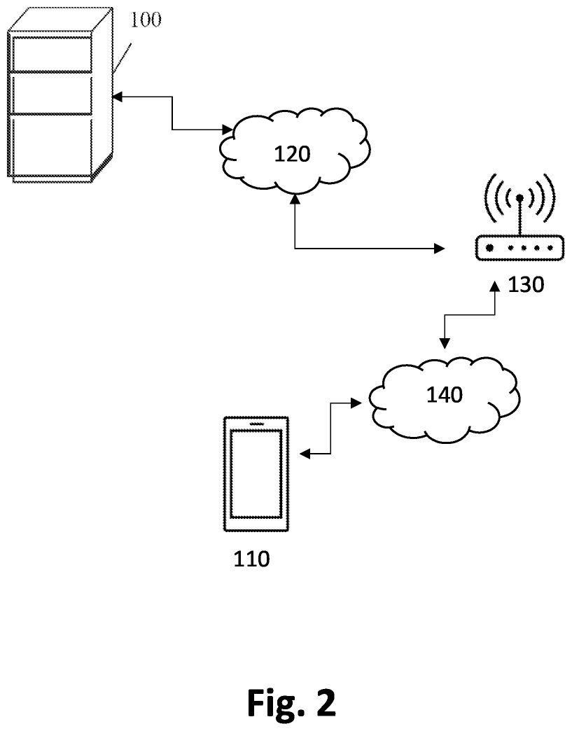

Referring to FIG. 2, which is an environmental diagram showing the system 100 that can be connected to the router 130 thorough a network 120. The network 120 can be an internet or any wide area network. FIG. 2 also shows a host device 110 that can be connected to the router 130 through an internal network 140. The internal network can be a local area network.

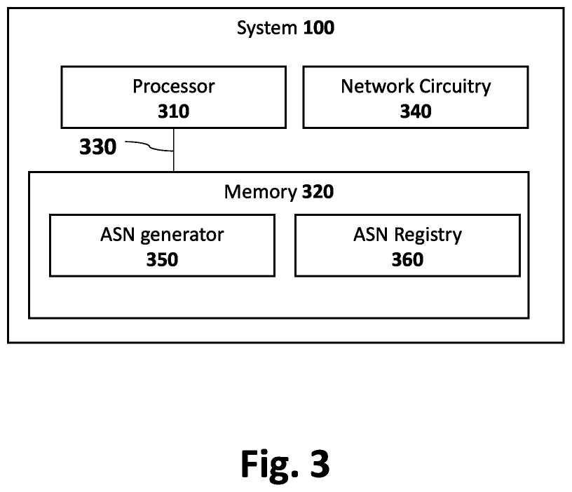

Referring to FIG. 3 which is a block diagram showing the system architecture. The system 100 can include a processor 310, a memory 320, wherein the processor and memory can be coupled through a system bus 330. A network circuitry 340 can also be provided to connect to an external network. The memory 320 can include an ASN generator 350 that upon execution by the processor can generate both public and private ASNs. The memory 320 can also include an ASN registry that can keep a record of generated public and private ASN numbers.

In one exemplary embodiment, disclosed is a DHCP extension that can capture the public facing ASN numbers and put them in a DNS record. The public ASN numbers can be tagged to the outgoing network packets which can be tracked to determine the route including origin of the network packets. The ASNs can be a combination of numerals of predetermined length generated randomly.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for identifying a source of network attack, the method comprising the steps of:
proving an autonomous system number record (ASN record) that includes an IP address, a public autonomous system number (public ASN), and a private autonomous system number (private ASN) in a host device; and
incorporating the IP address and the public ASN in network packets transmitted by the host device.

2. The method according to claim 1, wherein the method further comprises the steps of:
transmitting, by the host device, a DHCP request to a Dynamic Host Configuration Protocol server; and
receiving, by the Dynamic Host Configuration Protocol server from an ASN generator, the public ASN and the private ASN.

3. The method according to claim 2, wherein the ASN generator is implemented within a system, the system comprises a processor and a memory, the memory includes the ASN generator and a registry, the method further comprises the steps of:
recording the public ASN and the private ASN in the registry.

4. The method according to claim 1, wherein the method further comprises the steps of:
tracking a route of the network packets in a network, transmitted by the host device to a client device, using the public ASN number and the private ASN number; and
blocking the host device by the client device from receiving the network packets.
